(19) United States
(12) Patent Application Publication
(10) Pub. No.: US 2016/0216425 A1
(43) Pub. Date: Jul. 28, 2016

(54) FUNCTIONALISED LAYERED STRUCTURE

(71) Applicant: ESSILOR INTERNATIONAL (COMPAGNIE GÉNÉRALE D'OPTIQUE), Charenton Le Pont (FR)

(72) Inventors: Jeanne MARCHAL, Charenton Cedex (FR); Montserrat BURGOS, Charenton Cedex (FR)

(21) Appl. No.: 14/910,137

(22) PCT Filed: Jul. 1, 2014
(86) PCT No.: PCT/FR2014/051690

§ 371 Date: Feb. 4, 2016

(30) Foreign Application Priority Data
Aug. 5, 2013 (FR) 1357770

(51) Int. Cl. G02B 5/30; G02C 7/12; G02B 1/14

(52) U.S. Cl. CPC G02B 5/3033; G02B 1/14; G02C 7/12

(57) ABSTRACT

A functionalized layered structure (2, 3, 20, 30) includes: a first element that is a first single-layer or multi-layer functional film (2A, 4); at least one second element selected among a second functional film (2B) and a basic optical element (200, 300); at least one first pressure-sensitive adhesive layer (5A, 5B, 5) placed in contact with at least one surface of the first element and at least one surface of the second element. The surfaces of the first and second element, which are intended for being placed in contact with the adhesive layer, are subjected to a surface treatment prior to being placed in contact, such that the decrease between the peel force when dry and the peel force when wet is no higher than at least 35%, inclusive.

The invention relates to a functionalized layered structure. It also relates to a functionalized layered structure including one or more functionalized films, whether or not associated with a base optical element. The base optical element may be, in particular, an ophthalmic lens. The invention is particularly advantageous in the case where the functionalized layered structure presents a functionality of polarization.

It is known to transfer, i.e. to assemble notably by bonding, a polarizing film of optical quality onto the optical surface of a base lens for producing a polarized ophthalmic lens. The function of this polarizing film is to eliminate from the field of vision any parasitic reflections originating from plane or horizontal quasi-plane surfaces, for example, such as a water body, thus reducing glare and improving contrast for the wearer of polarizing ophthalmic lenses.

These polarizing films are generally based on polyvinyl alcohol (PVA), or polyethylene terephthalate (PET). (PVA) films are generally interposed between two protective films which are notably based on cellulose triacetate (CTA) or polycarbonate (PC), or cyclo-olefin copolymer (COC). This protective film is used to protect the polarizing film against external mechanical stresses during its assembly with the base optical element or finished lens, e.g. by involuntary tearing, scratching or dissemination of a foreign substance in the polarizing film material. In addition, the protective film facilitates handling the polarizing optical element during the manufacturing cycle. These protective films may also be used, in the case of PVA, to protect it from external attack, PVA notably exhibiting a hygroscopic behavior.

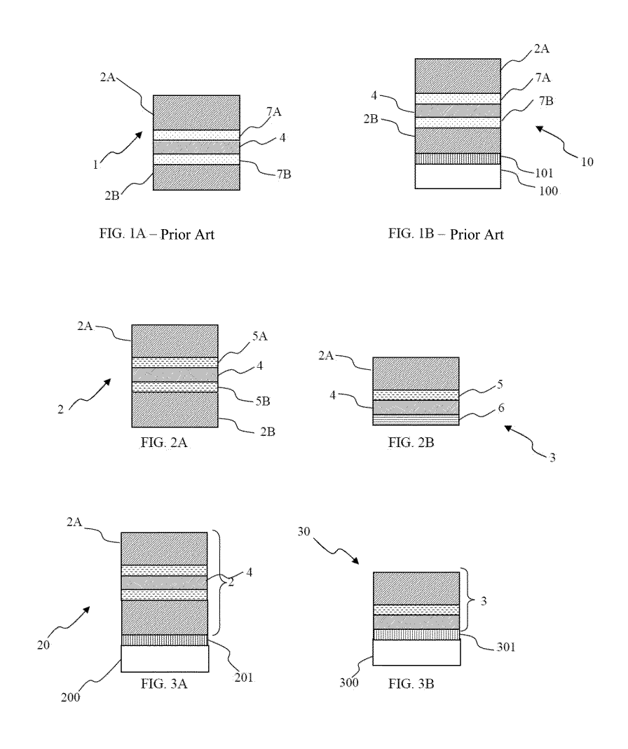

A layer of PVA-based glue is interposed between the polarizing film and the protective film(s) for ensuring the cohesion of this assembly. FIG. 1A illustrates a layered structure 1 including a polarizing film 4 according to the prior art, composed of a CTA protective film 2A, a layer of PVA-based glue 7A, a PVA polarizing film 4, a second layer of glue 7B and a second CTA protective film 2B. FIG. 1B represents an assembly between the prior art layered structure 1 and a base optical element 100 for producing a polarizing optical element. One of the faces of the polarizing layered structure 1, corresponding to the free face of one of the two protective films 2B is bonded onto the optical surface of the base optical element 100 by means of an adhesive layer 101.

The polarizing base optical element may then be coated and then trimmed so that its outline fits the shape of the frame that receives it. The step of coating may comprise surface preparations in the presence of water.

The step of peripheral machining may implement a standard method including at least one step of grinding in which the lens is subjected to mechanical stresses in the presence of water. The polarizing layered structure as described above does not support such conditions (surface preparation, machining), which generally leads to detachment at the interfaces of the layers. Indeed, the PVA-based glue which provides good adhesion between the polarizing film and the protective films is unfortunately soluble in water and the CTA//glue//PVA//glue//film separates most of the time during the steps involving water, such as the surface preparation steps before coating, or following a mechanical force in the presence of water (trimming).

One aim of the present invention therefore consists in providing a functionalized layered structure including at least one functionalized film, which can be simply implemented, while conferring a tough and durable adhesion on the structure during the successive stages of manufacturing the optical element, and notably the ophthalmic lens, notably during the use of post-processing in the presence of water. (e.g.: surface preparation, coating, trimming of the ophthalmic lens).

For this, the invention provides a functionalized layered structure including
a first element representing a first single-layer or multi-layer functional film;
at least one second element selected from a second functional film and a base optical element;
at least one first pressure-sensitive adhesive layer, placed in contact with at least one surface of said first element and at least one surface of said second element. According to the invention, the surfaces of said first element and second element intended to be placed in contact with said at least one adhesive layer are subjected to a surface treatment, prior to being placed in contact, so that the decrease between the peel force in a dry condition and the peel force in a wet condition is at least less than or equal to 35% inclusive.

According to the invention, the surfaces of said first element and second element having been subjected to a surface treatment present a surface energy of at least 60 mN/m.

According to the invention, the surface treatment is a plasma treatment carried out in an inert nitrogen atmosphere, with a dosage ranging from 40 to 100 W·min/m².

According to the invention, the surface treatment is a Corona treatment carried out in ambient air, with a dosage ranging from 40 to 50 W·min/m².

According to the invention, the first element represents a multi-layer functional film, in which at least two layers are assembled by means of a pressure-sensitive adhesive layer, the surfaces of said at least two layers are subjected to a surface treatment prior to their assembly.

Preferably, the first element represents a functional film including at least one functionality selected from color, polarization, photochromic, electrochromic, shock resistant, abrasion resistant, antistatic, antiglare, antifouling, anti-fog, rain repellent, or a spectral filter on a specified wavelength band, e.g. a blue light filter.

According to a preferred embodiment of the invention, the first element is a polarizing multi-layer film including at least two films, representing a polarizing film and a protective film respectively. The polarizing film and the protective film are then assembled by means of a first pressure-sensitive adhesive layer.

According to one embodiment of the invention, the second element is a base optical element.

According to one embodiment of the invention, the second element is a second functional film such as a protective film.

According to another embodiment of the invention, the structure further includes a second second element representing a base optical element, said second second element being placed in contact with the first second element, by means of a second adhesive layer.

According to the invention, this second adhesive layer is a pressure-sensitive adhesive layer as defined above or an adhesive including at least one layer of adhesive material selected from a layer of latex and a layer of hot-melt adhesive material (HMA).

Preferably, said second adhesive layer is a pressure-sensitive adhesive layer. In a particularly preferred way, said second adhesive layer, selected as being a pressure-sensitive adhesive layer, is further selected as being identical to said first pressure-sensitive adhesive layer, i.e. of the same chemical composition.

According to a preferred embodiment of the invention, the structure defining a polarization functionality includes:
a first element representing a protective film and a polarizing film;
a second element including a protective film;
a pressure-sensitive adhesive layer interposed between said films;
the surfaces of said first element and second element intended to be placed in contact with said adhesive layer being subjected to a surface treatment, prior to being placed in contact, so that the decrease between the peel force in a dry condition and the peel force in a wet condition is at least less than or equal to 35% inclusive.

In this structure, the protective film prevents the polarizing film from being degraded and facilitates the handling of the polarizing structure. This helps to better preserve the polarizing film when the latter has not yet been applied against a base optical element or once applied on the optical element when the lens is worn.

This protective film may be based on cellulose triacetate (CTA), cellulose acetate-butyrate (CAB), polyethylene terephthalate (PET), polycarbonate, polyamide, cyclo-olefin copolymer (COC) or cyclo-olefin polymer (COP).

In the rest of the description, this layered structure including a polarizing film is also referred to as the polarizing structure.

According to the invention, the use of the ‘Pressure-Sensitive Adhesive’ material or PSA for bonding the PVA polarizing film with a CTA protective film and the plasma or corona treatment is particularly advantageous compared with a conventional structure since it can be used to produce the polarizing structure in a simple way while preserving the quality of polarization of the polarizing film. In addition, it is notable that the specific combination between this adhesive material with a plasma surface treatment and a well-adjusted dosage of the surface energies of the films, creates strong bonds with the film interfaces and ensures a strong cohesion within the structure, and that this cohesion is maintained even in the presence of water.

The inventors have found that it is necessary to maximize the surface energy of the films, so that there is effective cooperation between the surface treatment and the adhesive material (PSA) interposed between the treated surfaces. They have thus found that this cooperation is effective when the polarizing structure presents a decrease between the peel force in a dry condition and the peel force in a wet condition of less than 35%.

This new polarizing structure prevents the phenomenon of separation between the polarizing film and the protective film during the trimming by grinding of a polarizing optical element with such a structure and during the surface preparation steps for depositing a coating.

The use of pressure-sensitive adhesive does not require using irradiation, of the ultraviolet radiation type, nor intensive heating for obtaining a permanent bonding. Thus the polarizing film is not altered or degraded by such irradiation or heating.

Preferably, the polarizing film presents a surface energy once treated of at least 56 mN/m and the protective film presents a surface energy once treated of at least 46 mN/m.

According to an alternative embodiment of the invention, the polarizing structure includes a single protective film arranged on one side of the polarizing film, the face of the polarizing film opposite said protective film being optionally covered by a packaging film.

Multiple pressure-sensitive adhesives may be used for assembling the polarizing structure. The pressure-sensitive adhesive material is preferably a polyacrylate-based compound.

Preferably, the pressure-sensitive adhesive layer has a thickness ranging from 5 μm to 150 μm, preferably from 10 to 50 μm in order to ensure an effective bonding while retaining a homogeneous thickness.

Preferably, the polarizing film is based on polyvinyl alcohol (PVA), with a typical thickness ranging from 20 to 80 μm. According to an alternative embodiment, it may be based on polyethylene terephthalate or PET with a typical thickness ranging from 15 to 100 μm.

The method for producing a polarizing structure as described above includes the following steps:
a) obtaining a polarizing film;
b) obtaining a protective film and arranging it on each side of the polarizing film;
c) interposing a pressure-sensitive adhesive layer between the films;
d) pressing the films together so as to obtain a permanent assembly.

This method further includes an additional step before step c) in which the surfaces of said films intended to be placed in contact with said pressure-sensitive adhesive layer are subjected to a surface treatment, prior to contact, so that the decrease between the peel force in a dry condition and the peel force in a wet condition is less than 35%.

When the pressure-sensitive adhesive layer is arranged between two peelable packaging films, step c) includes the following steps:

c1) peeling off one of the two peelable packaging films so as to reveal one face of the pressure-sensitive adhesive layer;

c2) pressing the revealed face of the adhesive material layer on the treated face of the polarizing film, through the other packaging film of said adhesive material layer;

c3) peeling off the other packaging film so as to reveal the other face of the adhesive material layer, and

d) pressing the protective film on said revealed face of the adhesive layer, with the treated face of the protective film facing the adhesive material layer.

When the adhesive material is in liquid form, step c) is performed by a method of centrifugation, coating, soaking or other method of deposition.

According to the invention, the structure may also define a polarizing ophthalmic lens including:
a first element representing a protective film and a polarizing film;
a second element representing a protective film;
a second second element representing a base optical element;
a first pressure-sensitive adhesive layer interposed between said films;
a second adhesive layer interposed between the protective film and the base optical element.

According to the invention, the surfaces of said films intended to be placed in contact with said first adhesive layer are subjected to a surface treatment, prior to being placed in contact, so that the decrease between the peel force in a dry condition and the peel force in a wet condition is at least less than or equal to 35% inclusive.

According to a preferred embodiment of the invention, the second adhesive layer has a three-layer structure comprising a layer of hot-melt adhesive material (HMA), sandwiched between two latex layers. Such an adhesive structure is described in WO 2011/053329.

Such an ophthalmic lens may further include at least one functional film arranged on the outer face of the protective film, on one side of the polarizing film opposite the base optical element. Such a film may confer additional functions on the optical element, such as elimination of light reflections, protection against shocks or scratches, protection against soiling, against mist or a color. These films may be arranged easily on the protective film (CTA).

Other features and advantages of the present invention will appear in the following description of non-restrictive examples of embodiment, with reference to the accompanying drawings, in which:

FIGS. 1A and 1B respectively represent a cross-sectional view of a layered structure including a polarizing film according to the prior art and that of a polarizing optical element including such a structure;

FIGS. 2A and 2B represent cross-sectional views of two polarizing structures according to the two embodiments of the invention;

FIGS. 3A and 3B represent cross-sectional views of a polarizing optical element including polarizing structures according to the two embodiments of the invention.

The examples above define a polarizing structure.

In accordance with FIG. 2A, a polarizing film 4 is interposed between two protective films 2A, 2B. This polarizing film 4 may consist mainly of polyvinyl alcohol, or PVA. It may have a thickness ranging from 20 to 80 μm. The protective films may have a thickness ranging from 40 μm to 200 μm.

For ensuring the cohesion of this assembly, a layer of pressure-sensitive adhesive material 5A, 5B is interposed respectively between the first protective film 2A and the polarizing film 4 and between the second protective film 2B and the polarizing film 4. This adhesive material layer may be made of polyacrylate, and presents a thickness of 5 μm to 150 μm. It holds the protective film permanently on the polarizing film.

According to the invention, the surfaces of the films 4, 2A, 2B which are intended to be placed in contact with the adhesive material layer 5A, 5B have been subjected to a plasma treatment.

This surface treatment maximizes the surface energy of the films that will be in contact with the adhesive material and maximizes the adhesion of the films. ‘Maximizing the adhesion of the films’, is understood to mean the fact of determining the maximum surface energy enabling a maximum peel force of the films to be achieved in a dry condition.

Surprisingly, this cooperation between the pressure-sensitive adhesive material and the surface treatment creates strong bonds at the film interfaces and ensures a strong cohesion within the structure even in a wet condition. For this, all the following conditions must be fulfilled:
the surface energies must be maximum
the peel force in a dry condition must be maximum
the difference between the peel force in a dry condition and the peel force in a wet condition must be at least less than or equal to a decrease of 35%.

Unlike a conventional polarizing structure, this new structure can be used to manufacture a lens (coating, trimming, etc.) in the presence of water without causing separation defects between the films in the polarizing structure.

In the polarizing structure 3 represented in FIG. 2B, one of the faces of the polarizing film 4 is covered with a protective film 2A. The opposite side of the polarizing film is optionally covered by a packaging film 6 appropriate to the polarizing film (termed a ‘liner’). An adhesive material layer 5 is interposed between the polarizing film 4 and the protective film 2. In this way both faces of the polarizing film are protected on one side by the protective film 2 and on the other by a packaging film 6.

A first method for producing a polarizing structure according to the invention illustrated in FIG. 2A is now described.

According to a first embodiment of the invention, the pressure-sensitive adhesive material layer 5A, 5B, the polarizing film 4 and the protective film 2A, 2B initially each take the form of a continuous film tightly fitted between two peelable packaging films (‘liners’) or without a liner.

Before interposing the adhesive material layer 5A, 5B between the polarizing film 4 and the protective film 2A, 2B, the three films 4, 2A, 2B are subjected to a plasma treatment separately or simultaneously. For carrying out this plasma or corona treatment, if there is a packaging film, it is previously removed. The treated face is intended to be subsequently placed in contact with the adhesive material layer.

The method for producing the polarizing structure comprises the following steps:

a) peeling off one of the two packaging films from the polarizing film 4 so as to reveal one face of the polarizing film,

b) peeling off one of the two packaging films from the protective film 2A so as to reveal one face of the protective film 2A,

b1) a plasma treatment is applied on these two revealed faces,

c) peeling off one of the two packaging films from the adhesive material layer and applying this layer against the plasma-treated face of the protective film through the packaging film of the adhesive material layer,

d) peeling off the second packaging film from the adhesive material layer and applying the stack of protective film+adhesive material against the plasma-treated face of the polarizing film.

Steps a) through d) thus enable the production of the polarizing structure comprising a single protective film (FIG. 2B). In producing the polarizing structure in FIG. 2A, steps a) through d) are repeated so as to add the second CTA protective film 2B.

According to another embodiment of the invention, since the adhesive material is packaged in liquid form, step c) is performed by a technique known to the person skilled in the art such as centrifugation (‘spin-coating’), coating, soaking or otherwise either on one face of the protective film or on one face of the polarizing film, both faces being previously plasma treated. This embodiment enables the thickness of the adhesive material layer to be monitored and optimized.

A functionalized layered structure including such a polarizing structure and a base optical element, is now described below.

A functionalized layered structure includes two main components: a base optical element represented by a base lens, and a first element including the polarizing structure including at least one functional film. The base lens is obtained from a semifinished lens with two surfaces opposite each other. One of these two surfaces, termed the first optical surface, is produced directly with a final curvature during the step of manufacturing the semifinished lens. Generally, this first optical surface may be the anterior convex surface of the base lens in the final ophthalmic lens, and it is determined by the shape of the mold, the molding technique or the injection technique. The other surface of the semifinished lens is temporary and intended to be surfaced subsequently to the optical correction of the lens wearer.

The semifinished or finished lens material may be a thermosetting material with a reflective index ranging from 1.5 to 1.76. It may also be a thermoplastic material with a reflective index ranging from 1.5 to 1.6.

The polarizing structure as described above and illustrated in FIGS. 2A and 2B may be thermoformed so that the shape of its curvature is compatible with one of the optical surfaces of the semifinished or finished lens. This method of preforming the polarizing structure is well known. This polarizing structure offers a technical advantage with respect to known polarizing structures through the presence of the two protective films, facilitating the thermoforming of the polarizing structure.

The polarizing structure is then applied by a method of lamination onto the first optical surface of the semifinished or finished lens. A layered structure of adhesive material which may be an adhesive material (PSA) or a triple layer of latex/HMA/latex is interposed between the polarizing structure and the base optical element for obtaining a permanent adhesion.

In the rest of the description this layered structure of adhesive material interposed between the polarizing structure and the base lens is also referred to as an adhesive structure.

According to an advantageous embodiment of the invention, this adhesive structure may consist of a single layer of pressure-sensitive adhesive material (PSA). This layer is particularly advantageous since it can be used to apply the polarizing structure on the optical surface of the base optical element in a simple way, while preserving the dioptric properties of the optical element. In order to increase the adhesive force between the polarizing structure and the optical element, before interposing the pressure-sensitive material layer between the polarizing structure and the optical surface of the base optical element, the surfaces which are intended to be placed in contact with the pressure-sensitive adhesive material layer were also subjected to a plasma or corona surface treatment.

A method of assembly is now described between a polarizing optical element and a polarizing structure according to the invention as described above and illustrated in FIG. 3A.

The method for producing the polarizing optical element represented in FIG. 3A comprises the following steps:

a) peeling off one of the two packaging films, if there is one, from the protection film, of the polarizing structure 2;

b) a plasma or corona treatment is applied on this revealed face and on the convex or concave face of the base optical element;

c) peeling off one of the two packaging films from the adhesive material layer 201 and applying this layer against the plasma-treated face of the base optical element 200 through the packaging film of the adhesive material layer;

d) peeling off the second packaging film from the adhesive material layer 201 and pressing the polarizing structure 2 against the convex or concave face of the base optical element so as to obtain a final assembly, the plasma-treated face of the polarizing structure 2 facing the revealed face of the adhesive material layer 201. Preferably, the polarizing structure is deposited on the convex face of the base optical element.

Preferably, the thickness of this adhesive material layer 201 ranges from 5 to 150 μm so as not to alter the nominal power of the optical element.

In a variant embodiment of the invention, the adhesive structure is first pressed against the revealed and plasma-treated face of the polarizing structure 2.

Before step a), the polarizing structure 2 is preformed prior to being pressed against the convex or concave face of the base optical element. This preforming may be performed in different ways. It notably includes a step of thermoforming during which it is heated before being deformed. The temperature of thermoforming is restricted so as not to alter the integrity of the polarizing film and so as to be able to easily conform to the shape of the convex or concave face of the base optical element. In the case where the adhesive structure is first pressed against the polarizing structure, the polarizing structure is preformed with the adhesive structure before the assembly is pressed against the convex or concave surface of the base optical element through the polarizing structure.

For applying the polarizing structure provided with a single protective film 3 onto the base optical element, the method is similar:

a) the packaging film 6 is peeled off from the polarizing film of the polarizing structure 3 so as to reveal one face of the polarizing film, the other face being covered by a protective film 2;

b) a plasma treatment is applied on this revealed face and on the convex or concave face of the base optical element 300;

c) peeling off one of the two packaging films from the adhesive material layer 301 and applying this layer against the plasma- or corona-treated face of the base optical element 300 through the packaging film of the adhesive material layer;

d) peeling off the second packaging film from the adhesive material layer 301 and pressing the polarizing structure 3 against the convex or concave face of the base optical element 300 so as to obtain a final assembly 30 with the plasma-treated face of the polarizing structure 3 facing the revealed face of the adhesive material layer 301.

These two methods of transfer relate to the case where the pressure-sensitive adhesive material layer is packaged in the form of a film. Of course, the polarizing optical element may also be produced when the adhesive material comes in liquid form.

In another embodiment of the invention, the adhesive structure 201, 301 may be a stack of three layers of Latex/hot-melt adhesive material (HMA)/Latex. The method of transfer of the polarizing structure no longer requires the plasma treatment step. Deposition of such an adhesive structure on the convex face of the base optical element 200, 300 is known. It consists of a set of steps for deposition by spin-coating and heating. Such an adhesive structure is described in WO 2011/053329.

In the polarizing optical elements thus obtained 20, 30, the polarizing films are protected on one side by a protective film and on the other side by the base optical element, against any soiling or scratching that could occur during the use of the optical element.

In the case where the polarizing structure is applied on the convex face of the optical element, functional coatings may be arranged on the protective film, on the outer face thereof, i.e. the face farthest away from the eyes of the wearer of the ophthalmic lenses. These coatings thus make it possible to further confer on the optical element a shockproof function, an antiglare function, an abrasion resistant, or antifouling, anti-fog, or colored function.

Protocol for Measuring Peel Force

The peel test consists of laminating a strip of pressure-sensitive adhesive material 25×70 mm in size on a strip of protective film. This strip (protective film+adhesive materials) is bonded onto a backing onto which a polarizing film is previously attached. This test is used to test the adhesion between the polarizing film and the protective film. The lens is conditioned at least 24 hours (at 23° C.±3° C., 50% RH±10%) before peeling. The film is peeled at an angle of 90° at a speed of 2.54 cm/min. Halfway through the test, a quantity of water is added to the interface for measuring the peel force in a wet environment. The force is expressed in N/25 mm.

Software continuously measures the peel force according to displacement. This force is averaged over a length of 10 mm for dry peeling and 15 mm for wet peeling.

Protocol for Measuring Surface Energy

For measuring the surface tension of polarizer and protective films, calibrated inks are applied on the surface of untreated films, and then a second time on the (plasma- or corona-) treated material. If the applied ink is stable, the substrate surface tension corresponds to at least the value of the test ink.

If the ink shrinks, the test is repeated with an ink showing a lower surface tension. The surface energy of the material is equal to the value of the last ink tested that showed good wetting for several seconds.

Protocol for Surface Treatment in the Examples Below

The protective films and the polarizing film are subjected to an oxidizing plasma (vacuum or atmospheric plasma), or a corona (atmospheric plasma), just before assembling the films together with the adhesive. The plasma parameters used in the examples below are as follows: Reference of the vacuum plasma machine: M4L, pressure 376 mTorr, gas flow rate 200 sccm of O₂, Power 390 W, exposure time 30 seconds.

### COMPARISON EXAMPLES

### Samples 1-6

These samples are all composed of a CTA//PVA//CTA layered structure, assembled with a layer of adhesive material sold by 3M under the reference 8146-1. This adhesive material layer has a thickness of 25 μm. The CTA films and the PVA film are supplied by FUJI and ONBITT respectively.

This polarizing layered structure is then laminated on an optical element marketed under the trade name Ormix with a base index of 1.6. The lamination method is described in WO 2012/078152.

For each of the samples with the exception of sample 1, the treated surfaces before assembly are explained in the ‘surface treatment’ column.

The samples are then washed, coated and finally trimmed with a Kappa (trade name) trimming machine.

Once trimmed, the samples are inspected to determine if there are cosmetic defects such as separation between films in the polarizing structure.

When the stack presents defects, this is indicated in the ‘Lens manufacture’ column of the table by a cross. When the trimming does not present any defect, this is indicated in the same column by ‘OK’.

### Samples 1-6 (Table 1)

TABLE 1

| | | | Dry peel | Wet peel | % | |
|---|---|---|---|---|---|---|
| | Surface | | force | force | between | Lens |
| | energy | | (N/25 mm) | (N/25 mm) | wet peel | manufacture |
| Sample | CTA//PVA | | CTA/PSA/ | CTA/PSA/ | and dry | (coating, |
| no. | (mN/m) | Surface treatment | PVA | PVA | peel | trimming) |
| 1 | 44/40 | No treatment | 11 | 4.7 | 57% | X |
| 2 | 44/58 | On PVA film | 11.5 | 3.9 | 66% | X |
| 3 | 50/40 | On CTA film | 10.4 | 9.5 | 9% | X |
| 4 | 50/58 | On CTA film + On | 16.6 | 15.5 | 7% | OK |
| | | PVA film | | | | |
| 5 | 44/40 | On adhesive | 12.7 | 4 | 69% | X |
| 6 | 44/58 | On PVA film + On | 12.6 | 4 | 68% | X |
| | | adhesive | | | | |

In table 1, the polarizing structure of sample 1 has been produced without surface treatment on the CTA and PVA films before assembly of the layers in sample 2, only the PVA film has been treated and in sample 3, only the CTA film has been treated. In these configurations, the surface energy is not maximum, the peel force decreases drastically when changing from a test performed in a dry condition to a test performed in a wet condition. For samples 1, 2, 5 and 6, this decrease ranges from 57% to 69%. After these samples have undergone the various steps of lens manufacture, the stack exhibits delamination defects, i.e. a separation between the films in the polarizing structure. With regard to sample 3, the surface treatment is applied only on the face of the CTA film, i.e. the protective film which presents the maximum surface energy, 50 mN/m. The PVA film which was not subjected to a surface treatment then exhibits a low surface energy, 40 mN/m. Although the decrease between the peel force in a dry condition and the peel force in a wet condition is small, of the order of 9%, this sample presents delamination defects after the trimming step. This result shows that it is necessary to treat both faces of the films intended to be placed in contact with the adhesive material in order to have effective cooperation between the treated films and the adhesive material together with a maximum peel force in a dry condition. In table 1, this peel force in a dry condition is 16.6 N/25 mm (sample no. 4).

The only configuration that works is sample 4 in which all the CTA and PVA film interfaces were treated before the production of the polarizing structure. It does not delaminate during the various steps of lens manufacture. The surface energy is then maximum, the treated surfaces of the CTA and PVA films respectively present 50 mN/m and 58 mN/m. This very good strength results in a very small decrease between the peel force in a dry condition and the peel force in a wet condition, which is of the order of 7%.

### Samples 7-12 (Table 2)

The samples are produced under the same conditions as samples 1 through 6.

The CTA//PVA//CTA polarizing structure, treated on all the film interfaces before assembly, assembled with a 3M adhesive ref. 8146-X, (of suitable chemical composition) presents different thicknesses of 5 μm (sample 7), 15 μm (sample 8), 25 μm (sample 9), 50 μm (sample 10), 75 μm (sample 11), 150 μm (sample 12). For all these samples, the plasma treatment is applied on CTA and PVA films so that their surface energy is maximum, equal respectively to 50 and 58 mN/m.

TABLE 2

| | | | | | % | |
|---|---|---|---|---|---|---|
| | Surface | | | | between | Lens |
| | energy | Thickness of | Dry peel | Wet peel | wet peel | manufacture |
| | CTA//PVA | 3 M | force | force | and dry | (coating, |
| Sample no. | (mN/m) | adhesive | (N/25 mm) | (N/25 mm) | peel | trimming) |
| 7 | 50/58 | 5 μm | 4.9 N | 4.5 N | 8% | OK |
| 8 | 50/58 | 15 μm | 8.8 N | 7.7 N | 12% | OK |
| 9 | 50/58 | 25 μm | 16.6 N | 15 N | 10% | OK |
| 10 | 50/58 | 50 μm | 20.4 N | 21.5 N | 5% | OK |
| 11 | 50/58 | 75 μm | 22.6 N | 24.6 N | 9% | OK |
| 12 | 50/58 | 150 μm | 28.5 N | 31.4 N | 10% | OK |

This table shows that the samples pass through the various lens manufacturing steps (wet conditions) regardless of the adhesive thicknesses. These test results show that when a pressure-sensitive adhesive material displaying good physical and chemical characteristics cooperates with a surface treatment (plasma or corona) which maximizes surface energies, the decrease between the peel force in a dry condition and the peel force in a wet condition is very small, ranging from 5% to 12%. For thin thicknesses, i.e. less than 25 μm, it is a maximum of 35% and of the order of 10% for adhesives exceeding a thickness of 25 μm.

The polarizing structure then does not display any defects (detachment, edge bubbles, deformations, etc.) after the lens manufacturing steps.

### Samples 13-16 (Table 3)

Samples 13 through 16 are produced under the same conditions as the samples above. The only difference lies in the nature of the pressure-sensitive adhesive material.

TABLE 3

| | | | | | % | |
|---|---|---|---|---|---|---|
| | Surface | | | | between | Lens |
| | energy | Thickness of | Dry peel | Wet peel | wet peel | manufacture |
| | CTA//PVA | the | force | force | and dry | (coating, |
| Sample no. | mN/m | adhesive | (N/25 mm) | (N/25 mm) | peel | trimming) |
| 13 | 50/58 | 5 μm | 5.5 N | 0.6 N | 89% | X |
| 14 | 50/58 | 10 μm | 10.7 N | 1.7 N | 84% | X |
| 15 | 50/58 | 15 μm | 13.8 N | 2.9 N | 79% | X |
| 16 | 50/58 | 25 μm | 17.1 N | 3.1 N | 82% | X |

For these test samples, the polarizing structure is assembled based on an adhesive material sold by Panac, reference PD S1, of different thicknesses: 5 μm (sample 13), 10 μm (sample 14), 15 μm (sample 15), 25 μm (sample 16). This table shows that the system does not work with a pressure-sensitive adhesive the chemical composition of which is inadequate and therefore does not cooperate with the plasma treatment even if the surface energy is maximum. This non-cooperation between the adhesive material and the plasma treatment accordingly results in a significant difference between the peel force in a dry condition and the peel force in a wet condition. It varies from 77% to 89%, whatever the adhesive thicknesses. The samples display defects after the various lens manufacturing steps.

1. A functionalized layered structure (2, 3, 20, 30) including
a first element representing a first single-layer or multi-layer functional film (2A, 4);
at least one second element selected from a second functional film (2B) and a base optical element (200, 300);
at least one first pressure-sensitive adhesive layer (5A, 5B, 5) placed in contact with at least one surface of said first element and at least one surface of said second element, wherein
the surfaces of said first element and second element intended to be placed in contact with said at least one adhesive layer, are subjected to a surface treatment, prior to being placed in contact, selected from a plasma treatment carried out in an inert nitrogen atmosphere with a dosage ranging from 40 to 100 W·min/m² and a Corona treatment carried out in ambient air with a dosage ranging from 40 to 50 W·min/m², so that the decrease between the peel force in a dry condition and the peel force in a wet condition is at least less than or equal to 35% inclusive.

2. The structure as claimed in claim 1, wherein the first element represents a multi-layer functional film, in which at least two layers are assembled by means of a pressure-sensitive adhesive layer, the surfaces of said at least two layers being subjected to a surface treatment prior to their assembly.

3. The structure as claimed in claim 1, wherein the first element represents a functional film including at least one functionality selected from color, polarization, photochromic, electrochromic, shock resistant, abrasion resistant, antistatic, antiglare, antifouling, anti-fog, rain repellent, and a spectral filter on a specified wavelength band.

4. The structure as claimed in claim 2, wherein the first element is a polarizing multi-layer film including at least two films, representing respectively a polarizing film (4) and a protective film (2A) and the polarizing film (4) and the protective film (2A) are assembled by means of a pressure-sensitive adhesive layer.

5. The structure as claimed in claim 1, wherein the second element is a base optical element (200, 300).

6. The structure as claimed in claim 1, wherein the second element is a second functional film (2B).

7. The structure as claimed in claim 6, further including a second second element representing a base optical element (200, 300), said second second element being placed in contact with the first second element, by means of a second adhesive layer (201, 301).

8. The structure as claimed in claim 7, wherein said second adhesive layer (201, 301) is a pressure-sensitive adhesive layer or an adhesive including at least one layer of adhesive material selected from a layer of latex and a layer of hot-melt adhesive material (HMA).

9. The structure as claimed in claim 1, the surfaces of said first element and second element having been subjected to a surface treatment present a surface energy of at least 60 mN/m.

10. The structure as claimed in claim 4, wherein the polarizing film presents a surface energy once treated of at least 56 mN/m and the protective film presents a surface energy once treated of at least 46 mN/m.

11. The structure as claimed in claim 1, wherein said first pressure-sensitive adhesive layer (5A, 5B, 5) and the second adhesive layer (201, 301) have a thickness ranging from 5 μm to 150 μm.

12. The structure as claimed in claim 7, wherein said first pressure-sensitive adhesive layer (5A, 5B, 5) and said second adhesive layer (201, 301) are identical.

13. The structure as claimed in claim 1, wherein the pressure-sensitive adhesive material is selected from a polyacrylate-based compound.

14. The structure as claimed in claim 1, wherein the polarizing film is based on polyvinyl alcohol (PVA) or polyethylene terephthalate (PET).

15. The structure as claimed in claim 1, wherein the protective film is based on cellulose triacetate, cellulose acetate butyrate, polyethylene terephthalate, polycarbonate, polyamide, cyclo-olefin copolymer (COC) or cyclo-olefin polymer (COP).

16. The structure as claimed in claim 1, further including:
a first element representing a protective film (2A) and a polarizing film (4);
a second element including a protective film (2B);
a pressure-sensitive adhesive layer (5A, 5B) interposed between said films, wherein the surfaces of said first element and second element intended to be placed in contact with said adhesive layer are subjected to a surface treatment, prior to being placed in contact, so that the decrease between the peel force in a dry condition and the peel force in a wet condition is at least less than or equal to 35% inclusive.

17. The structure as claimed in claim 1, which defines a polarizing ophthalmic lens.

18. The structure as claimed in claim 17, further including:
a first element representing a first protective film (2A) and a polarizing film (4);
a second element representing a second protective film (2B);
a second second element representing a base optical element (200);
a first pressure-sensitive adhesive layer (5A, 5B) interposed between said films;
a second adhesive layer (201) interposed between the second protective film (2B) and the base optical element (200), wherein the surfaces of said films (2A, 2B, 4) intended to be placed in contact with said first adhesive layer (5A, 5B) are subjected to a surface treatment, prior to being placed in contact, so that the decrease between the peel force in a dry condition and the peel force in a wet condition is at least less than or equal to 35% inclusive.

19. The structure as claimed in claim 2, wherein the second element is a base optical element (200, 300).

20. The structure as claimed in claim 2, wherein the second element is a second functional film (2B).
